(19) United States
(12) Patent Application Publication
(10) Pub. No.: US 2004/0022186 A1
(43) Pub. Date: Feb. 5, 2004

(54) Methods, apparatus and program product for controlling network security

(75) Inventors: Garry Michael Kump, Apex, NC (US); Francis Edward Noel JR., Durham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/208,281

(22) Filed: Jul. 30, 2002

(51) Int. Cl. H04J 1/16; H04J 3/14

(52) U.S. Cl. 370/229; 370/230.1

(57) ABSTRACT

Methods, apparatus and program products which monitor access points through which data can be exchanged with a network, identify an unauthorized access point, and selectively apply filters to the flow of data through an unauthorized access point.

### RELATED APPLICATION

The invention here described is related to an invention described in co-pending application Ser. No. 10/107,794 filed Mar. 27, 2002 and assigned to common ownership with this application.

### BACKGROUND OF THE INVENTION

The description which follows presupposes knowledge of network data communications and switches and routers as used in such communications networks. In particular, the description presupposes familiarity with the ISO model of network architecture which divides network operation into layers. A typical architecture based upon the ISO model extends from Layer 1 (also sometimes identified as “L1”) being the physical pathway or media through which signals are passed upwards through Layers 2, 3, 4 and so forth to Layer 7, the last mentioned being the layer of applications programming running on a computer system linked to the network. In this document, mention of L1, L2 and so forth is intended to refer to the corresponding layer of a network architecture. The disclosure also presupposes a fundamental understanding of bit strings known as packets and frames in such network communication.

The 802.11 standard is a family of specifications created by the Institute of Electrical and Electronics Engineers Inc. for wireless local area networks in the 2.4-gigahertz bandwidth space. 802.11 can be thought of as a way to connect computers and other electronic devices to each other and to the Internet at very high speed without any cumbersome wiring—basically, a faster version of how a cordless phone links to its base station. With 802.11, electronic devices can talk to each other over distances of about 300 feet at 11 megabits a second, which is faster than some wired networks in corporate offices.

Devices using 802.11—increasingly known as Wi-Fi—are relatively inexpensive. A network access point can be bought for about $500 and will coordinate the communication of all 802.11 equipped devices within range and provide a link to the Internet and/or any intranet to which the access point is linked. The cards that let a laptop computer or other device “plug” into the network cost $100 to $200. Some personal communication devices come enabled for 802.11 communications without the need of an additional card. Wireless 802.11 cards and access points are flying off the shelves of computer suppliers. People want and find easy connectivity with 802.11-standard products. Such networks are also know by more formal names as ad-hoc wireless networks and, in some instances, as mobile ad-hoc networks or MANETs.

Providing so much wireless speed at a modest price is having profound implications for a world bent on anytime/anywhere communication. Wi-Fi is spreading rapidly. College students are setting up networks in their dorms and cafeterias. Folks in some parts of San Francisco are building 802.11 networks to cover their neighborhoods. Starbucks Corp., United Airlines Inc., and Holiday Inn, among others, are installing 802.11 networks in their shops, airport lounges, and hotels, in a nod toward their customers' desire to stay connected. It has been reported that, in 2000, the number of people using wireless local area networks rose by 150 percent, according to Synergy Research Group. Cahners In-Stat Group, a Scottsdale, Ariz.-based market research firm, sees the number of wireless data users in business growing from 6.6 million today to more than 39 million by 2006. Feeding this trend is the fact that almost a quarter of all workers in small or medium-sized business are mobile workers, spending at least 20 percent of their time away from the office. Wireless e-mail is their prime need, which is why mobile computing products with always-on e-mail capability continue to sell so well. In early 2002, it was estimated that between 25,000 and 50,000 people install and manage 802.11 networks every day.

The wireless trend will inevitably spill over into the home networking market. A major reason is price: The cost of access points, equipment that connects to the wireless network; and network interface cards, or NICs, that make the link between the PC and the access point, is dropping. Those low prices catch the eye of shoppers, which is why the home market grew 20 percent in the last quarter of 2001.

Successor technologies to 802.11 are on the horizon. One is ultra-wide band radio technology or UWB, which uses a wide spectrum technology at low power to transfer data at a very high speed. UWB will be perhaps ten times faster than 802.11, yet suffer from some of the same exposures described here. Another is the inclusion of radio frequency function directly on chips which perform other functions such as system central processors.

And there's the problem, and a real dilemma it presents. Once again, information technology administrators and users are caught between ease of use and requirements for security. There are two major problems with wireless today and which can be anticipated as remaining into the future. One is that all too often it is implemented without any kind of security at all. The other is that the out-of-the-box security options, if the consumer switches them on, are completely ineffectual. According to Gartner Dataquest, about thirty percent of all companies with a computer network have some kind of wireless network, either official or rogue. Furthermore, if the business or cafe next door has a wireless network, the business might be in trouble.

Wireless is so wide open, in fact, that it has given birth to a new technologist Olympic sport: war driving. The game is all about seeing how many potential targets can be found. All that is needed to play is a laptop, a wireless PC card, and some software. War driving has been widely discussed in the technical press and on technology web sites, and does occur on a regular basis. The new hobby for bored teenagers and technogeeks is to drive around with an antenna and GPS strapped to a laptop hunting for wireless access points. While most are not maliciously attacking networks and are carefully preventing themselves from accessing the network and any of the files contained therein, not everyone is so polite.

One of the more popular tools used in war driving, NetStumbler, tells you the access point name, whether encryption is enabled, and numerous other bits of information. NetStumbler is also a great tool for administrators trying to identify rogue, unauthorized, access points which have been connected in their organizations. One user picked up twenty access points during a quick drive down Highway 101 in Silicon Valley. Another user, cruising the financial district in London and using an antenna made from an empty Pringles brand potato chip can found almost sixty access points in thirty minutes. Kismet is a wireless network sniffer for Linux that includes many of the same capabilities as NetStumbler. AirSnort is a Linux-based tool that tries to recover encryption keys. These and many more tools are freely available on the Internet.

Although organizations still must be vigilant about securing their main Internet gateway, the corporate perimeter is expanding wirelessly. How many users access the internal network via a VPN or other means of remote access? How many of those users have wireless networks at home? Are they secure? If not, your internal network is vulnerable, regardless of how secure your main Internet gateway is. Until 802.11 and UWB are made and proven secure, smart network managers will keep worrying. Particularly where employees lacking authorization to do so go to their friendly computer supply store, buy a wireless access point, bring it to their place of employment, and power it up connected to their employer's intranet.

It is important to note that access nodes or points today generally function at Layer 2 and have no knowledge of Layer 3 addressing, while the edge router which they are connected to has full knowledge of Layer 3 addressing. As technology has advanced more and more function has been incorporated in to the assess points. For example, originally these were simplistic “wiring concentrators” such as the IBM 8228 which was a completely unpowered product. Today these access points typically are Layer 2 switches with full knowledge of the Layer 2, or Medium Access Control (MAC), addresses of the devices that are connected to them, be they wireless or wired.

In the future these access points, with the advent of low cost Network Processors (as separately described in the literature), will become fully Layer 3 aware, particularly in respect to knowing the IP address of end stations connected to them. Of course today, an edge router already has this knowledge of IP addresses of end devices connected directly to it. Today all edge nodes and some access nodes have the capability to be, via the network, connected to a Network Management console using a messaging protocol known as Simple Network Management Protocol (SNMP). In the future all access nodes will have this capability.

### SUMMARY OF THE INVENTION

The present invention has as a purpose enabling a network administrator or manager to control the activity of a rogue, or unauthorized, access point, thereby assisting in enhanced security for networks.

The purpose is pursued by methods, apparatus and program products which monitor access points through which data can be exchanged with a network, identify an unauthorized access point, and control certain activity through the access point.

### BRIEF DESCRIPTION OF THE DRAWINGS

Some of the purposes of the invention having been stated, others will appear as the description proceeds, when taken in connection with the accompanying drawings, in which:

FIG. 1 is a schematic representation of a network installed within a facility, including workstation computer systems and a server computer system, and to which an unauthorized access point has been attached;

FIG. 2 is a schematic representation of a wireless access point such as may be functional in the network shown in FIG. 1 and which incorporates a network processor;

FIG. 3 is a simplified flow chart showing steps performed in the network of FIG. 1;

FIG. 4 is a view of a computer readable medium bearing a program effective when executing on an appropriate one of the systems of FIG. 1 to implement the steps of FIG. 3.

### DESCRIPTION OF THE PREFERRED EMBODIMENT(S)

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

As briefly mentioned above, a problem with the proliferation of the 802.11 standard is that it is easily possible for a person to set up a wireless access point to a network, without the information technology (IT) organization responsible for managing the network knowing about it. This is a problem because such access points may be (and usually are) misconfigured, thus granting to the world access to the network and data residing therein.

In this invention, on a periodic or random basis, a central site network management console can interrogate, using SNMP or more sophisticated techniques, the wireless access or wireless edge nodes. The goal in this interrogation is to determine the latest addition to the Layer 3 routing tables and to monitor the latest entries and their traffic flow for abnormal activities such as denial of server access. Alternatively, if interrogation is of a Layer 2 device, then the “trusted neighbor table” would be interrogated for the most recent entries and traffic monitored as above.

If immediate action is desired, then through SNMP and other techniques, either Layer 2 or Layer 3 filter tables (as appropriate) can immediately be set to deny assess to the network. If it is desired to attempt to apprehend the intruder, the location of the rogue access point may be determined using the signal strength techniques described in the aforementioned co-pending application which is hereby incorporated by reference to any extent necessary to an understanding of this invention. To “stall” the intruder, the filtering tables can be set in either the Layer 2 or Layer 3 case to route the traffic exchanged with the rogue access point to a secure server, which can be programmed with a series of scripts giving an intruder the feeling that they are gaining access to the network.

Important characteristics of this invention include the abilities to interrogate the routing tables in an edge router or the trusted neighbor table in an access point, interrogate these tables in a random or deterministic fashion to determine if there are new entries, monitor the traffic flow from these new entries to determine if they are having issues with the network, such as service denial, and, through routing and trusted neighbor tables to filter the intruder's traffic and either shut them down by appropriate entries into the tables or route their flows to a secure server to initialize a sequence of events to apprehend the intruder.

Thus this invention provides a way to control unauthorized access points quickly, without the necessity of having a wandering user.

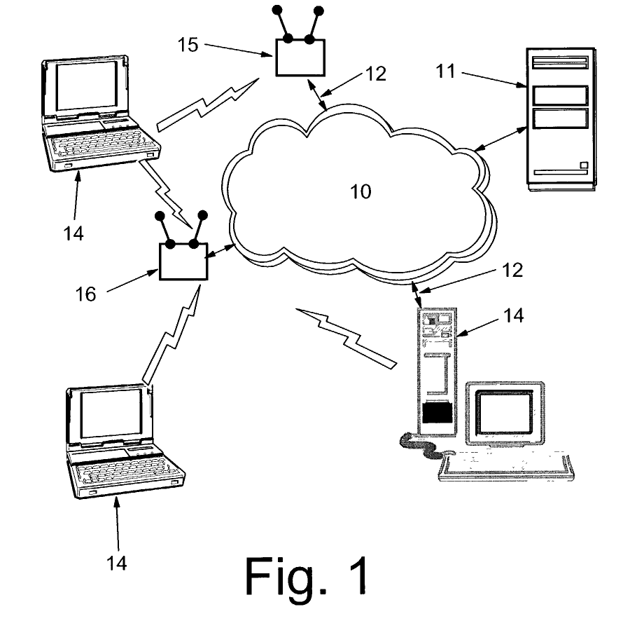

Referring now more particularly to the Figures, FIG. 1 illustrates a network 10 having a server computer system 11, a plurality of authorized access points 12 which may be either wireless or wired, and a plurality of workstation computer systems 14. Each workstation computer system 14 is coupled to the network, either through a wireless connection or possibly through a wired connection. Depending upon the size and scope of a facility, managed networks may have a mix of types of systems and types of connections. The workstations may be notebook computer systems, personal digital assistant systems, advanced function telephones, desktop or minitower systems, or other devices capable of accessing the network 10 through the access points.

Access to the network 10 may come through an authorized wireless access point 15 and, in the illustrated network, through an unauthorized or rogue wireless access point 16. The rogue access point 16 may have been established by an individual or group acting without the knowledge or permission of the information technology management. In accordance with some purposes of this invention, control over the activity passed through the rogue access point 16 is a goal to be accomplished.

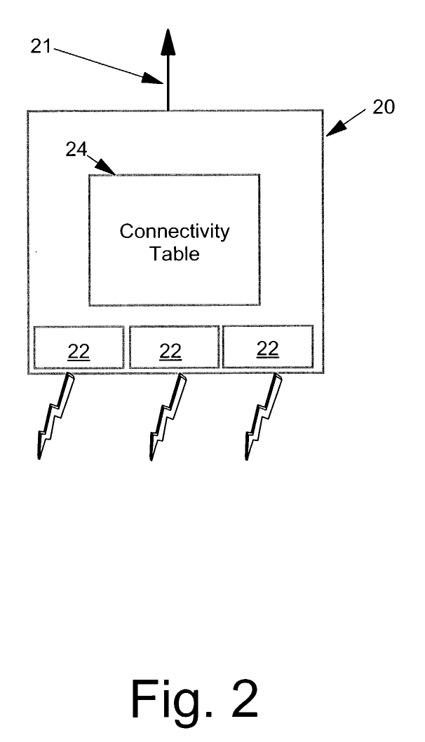

An exemplary access point in accordance with this invention is illustrated in FIG. 2, where the access point is generally indicated at 20. The access point 20 is a node in the network 10, connected to certain other elements through a wired connection or interface 21 and possibly to others through wireless connections or interfaces 22. The access point 20 has a connectivity table 24 stored therewithin. The table may be stored in a network processor interposed between the two levels of interfaces 21, 22.

Industry consultants have defined a network processor (herein also mentioned as an “NP”) as a programmable communications integrated circuit capable of performing one or more of the following functions:

Packet classification—identifying a packet based on known characteristics, such as address or protocol

Packet modification—modifying the packet to comply with IP, ATM, or other protocols (for example, updating the time-to-live field in the header for IP)

Queue/policy management—reflecting the design strategy for packet queuing, de-queuing, and scheduling of packets for specific applications

Packet forwarding—transmission and receipt of data over the switch fabric and forwarding or routing the packet to the appropriate address

Although this definition is an accurate description of the basic features of early NPs, the full potential capabilities and benefits of NPs are yet to be realized. Network processors can increase bandwidth and solve latency problems in a broad range of applications by allowing networking tasks previously handled in software to be executed in hardware. In addition, NPs can provide speed improvements through architectures, such as parallel distributed processing and pipeline processing designs. These capabilities can enable efficient search engines, increase throughput, and provide rapid execution of complex tasks.

Network processors are expected to become the fundamental network building block for networks in the same fashion that CPUs are for PCs. Typical capabilities offered by an NP are real-time processing, security, store and forward, switch fabric connectivity, and IP packet handling and learning capabilities. NPs target ISO layer two through five and are designed to optimize network-specific tasks.

The processor-model NP incorporates multiple general purpose processors and specialized logic. Suppliers are turning to this design to provide scalable, flexible solutions that can accommodate change in a timely and cost-effective fashion. A processor-model NP allows distributed processing at lower levels of integration, providing higher throughput, flexibility and control. Programmability can enable easy migration to new protocols and technologies, without requiring new ASIC designs. With processor-model NPs, network equipment vendors benefit from reduced nonrefundable engineering costs and improved time-to-market.

In accordance with conventional network operation, nodes in the network 10 maintain connectivity tables containing addresses of others nodes with which communication can be established. Depending upon the characteristics of the node in which such a table is maintained, the table may be known as a routing or trusted neighbor table. Such tables are periodically refreshed based on broadcast advertisements of detected connectivity. The present invention takes advantage of such routing or trusted neighbor tables and the ability of an intelligent node to perform processing as described above.

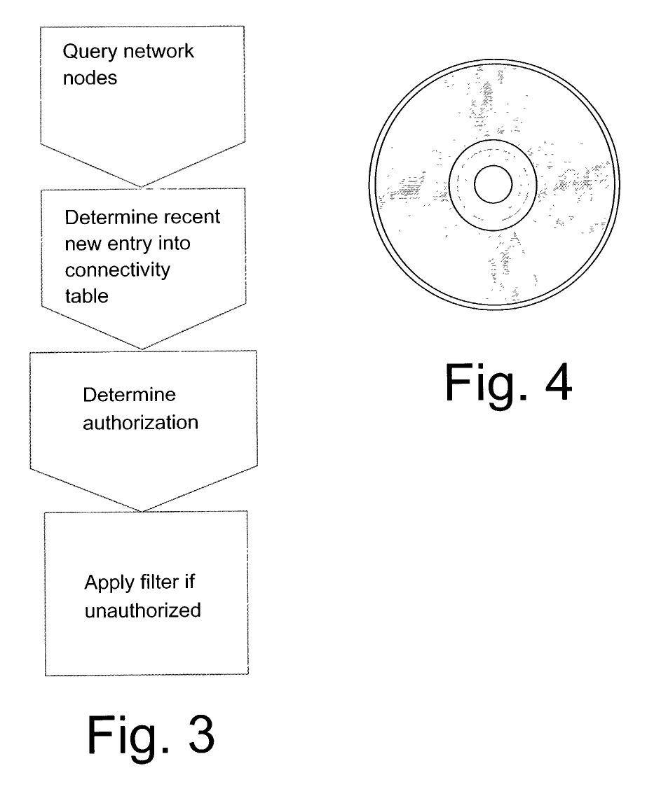

In particular, and referring now to FIG. 3, at periodic intervals, either predetermined or random, a network management console program executing, for example, on the server 11 will query the network nodes including wireless access points such as are identified at 15 and 16 in FIG. 1. The query, using SNMP or other possibly more sophisticated techniques, will determine recent entries into routing and trusted neighbor tables maintained in the network. Recent entries will then be subjected to monitoring of their traffic flow for abnormal activities such as a denial of service attack or sought after access to secured data.

If an immediate action is desired, then through SNMP or other techniques L2 or L3 filter tables can immediately be set to deny access to the network. Alternatively, traffic originating through an identified rogue access point can be directed to a secure server programmed with a series of scripts which “spoof” a user by appearing to give network access while in fact isolating the node from such access. These steps are as illustrated.

Programs effective to implement these steps while running on a system such as the server 11 may be distributed by writing onto appropriate computer readable media, such as the diskette 40 shown in FIG. 4.

In the drawings and specifications there has been set forth a preferred embodiment of the invention and, although specific terms are used, the description thus given uses terminology in a generic and descriptive sense only and not for purposes of limitation.

What is claimed is:

1. A method comprising the steps of:
monitoring access points through which data can be exchanged with a network, identifying an unauthorized access point,
monitoring traffic passing through the identified unauthorized access point, and
applying traffic filtering to monitored traffic passing through the identified unauthorized access point.

2. A method according to claim 1 wherein the step of monitoring comprises intermittently and periodically querying network nodes for recent entries into node identifying connectivity tables maintained at the nodes.

3. A method according to claim 2 wherein the step of monitoring comprises querying network nodes at predetermined regular intervals.

4. A method according to claim 2 wherein the step of monitoring comprises querying network nodes at random irregular intervals.

5. A method according to claim 1 wherein the step of applying traffic filtering comprises denying access to the network through the identified unauthorized access point.

6. A method according to claim 1 wherein the step of applying traffic filtering comprises directing traffic exchanged with the network through the identified unauthorized access point to a secure server.

7. A method comprising the steps of:
querying access points through which data can be exchanged with a network and gathering connectivity table information from a queried access point,
reporting through the network to a server computer system the information gathered by querying,
identifying an unauthorized access point by operation of the server system, and
selectively applying a filter to the traffic exchanged with the network though the identified unauthorized access point.

8. Apparatus comprising:
a server computer system,
a network interface connected to said system and providing a communication channel between said system and a network,
an access point identification program stored accessibly to said system and cooperating therewith when executing to identify unauthorized nodes accessible through said interface, and
a traffic filter controlling program stored accessibly to said system and cooperating therewith when executing to selectively impose a filter on traffic exchanged with the network through an unauthorized node.

9. Apparatus according to claim 8 wherein said traffic filter controlling program is effective to revise connectivity tables stored in the network and deny network access to an unauthorized node.

10. Apparatus according to claim 8 wherein said traffic filter controlling program is effective to reroute traffic exchanged with the network through the unauthorized node to a secure server.

11. A program product comprising:
a computer readable medium; and
a program stored on said medium accessibly to a computer system, said program when executing on a system:
monitoring access points through which data can be exchanged with a network, identifying an unauthorized access point,
monitoring traffic passing through the identified unauthorized access point, and
applying traffic filtering to monitored traffic passing through the identified unauthorized access point.

12. A program product comprising:
a computer readable medium; and
a program stored on said medium accessibly to a computer system, said program when executing on a system:
querying access points through which data can be exchanged with a network and gathering connectivity table information from a queried access point,
reporting through the network to a server computer system the information gathered by querying,
identifying an unauthorized access point by operation of the server system, and
selectively applying a filter to the traffic exchanged with the network though the identified unauthorized access point.
